(19) United States
(12) Patent Application Publication
(10) Pub. No.: US 2022/0292861 A1
(43) Pub. Date: Sep. 15, 2022

(54) Docket Analysis Methods and Systems

(71) Applicant: Xero Limited, Wellington (NZ)

(72) Inventors: Kiarie Ndegwa, Wellington (NZ); Yu Wu, Wellington (NZ); Salim M.S. Fakhouri, Wellington (NZ)

(21) Appl. No.: 17/770,046

(22) PCT Filed: Oct. 22, 2020
(86) PCT No.: PCT/AU2020/051140

§ 371 Date: Apr. 18, 2022

(30) Foreign Application Priority Data
Oct. 25, 2019 (AU) 2019904025

(51) Int. Cl. G06V 30/413; G06V 30/412; G06V 10/82; G06V 10/774; G06T 7/11; G06T 7/73

(52) U.S. Cl. CPC G06V 30/413; G06V 30/412; G06V 10/82; G06V 10/774; G06T 7/11; G06T 7/73

(57) ABSTRACT

A computer implemented method for processing images for docket detection and information extraction. The method comprises receiving, at a computer system, an image comprising a representation of a plurality of dockets; and detecting, by a docket detection module of the computer system, a plurality of image segments. Each image segment is associated with one of the plurality of dockets. The method comprises determining, by a character recognition module of the computer system, docket text comprising a set of characters associated with each image segment; and detecting, by a data block detection module of the computer system, based on the docket text, one or more data blocks in each of the plurality of docket segments, wherein each data block is associated with a type of information represented in the docket text.

### TECHNICAL FIELD

Described embodiments relate to docket analysis methods and systems. In particular, some embodiments relate to docket analysis methods and systems for processing images to detect dockets and extract information from the detected dockets.

### BACKGROUND

Manually reviewing dockets to extract information from them can be a time intensive, arduous and error prone process. For example, dockets need to be visually inspected to determine the information from the dockets. After the visual inspection, the determined information needs to be manually entered into a computer system. Data entry processes are often prone to human error. If a large number of dockets need to be processed, significant time and resources may be expended to ensure that complete and accurate data entry has been performed.

It is desired to address or ameliorate some of the disadvantages associated with prior methods and systems for processing images for docket detection and information extraction, or at least to provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a computer implemented method for processing images for docket detection and information extraction, the method comprising: receiving, at a computer system, an image comprising a representation of a plurality of dockets; detecting, by a docket detection module of the computer system, a plurality of image segments, each image segment being associated with one of the plurality of dockets; determining, by a character recognition module of the computer system, docket text comprising a set of characters associated with each image segment; and detecting, by a data block detection module of the computer system, based on the docket text, one or more data blocks in each of the plurality of docket segments, wherein each data block is associated with a type of information represented in the docket text. For example, the dockets may comprise one or more of an invoice, a receipt or a credit note.

For example, the docket detection module and the data block detection modules may comprise one or more trained neural networks. The one or more trained neural networks may comprise one or more deep neural networks and the data block detection is performed using a deep neural network configured to perform natural language processing.

In some embodiments, the method may further comprise determining by the data block detection module a data block attribute and a data block value for each detected data block based on the docket text, wherein the data block attribute classifies the data block as relating to one of a plurality of classes and the data block value represents the value of the determined data block attribute. The data block attribute may comprise one or more of transaction date, vendor name, transaction amount, tax amount, currency, transaction date, or payment due date.

In some embodiments, the character recognition module is configured to determine coordinate information associated with the docket text, and the data block detection module determines a data block attribute and a data block value based on the docket text and the coordinate information associated with the docket text; wherein the data block attribute classifies the data block as relating to one of a plurality of classes and the data block value represents a value of the determined attribute.

Performing image segmentation may comprise determining, by the image segmentation module, coordinates defining a docket boundary for at least some of the plurality of dockets in the image; and extracting, by the image segmentation module, the docket segments from the image based on the determined coordinates.

The deep neural network configured to perform natural language processing may be trained using a training data set comprising training docket text comprising training data block values and data block attributes. The neural networks comprising the docket detection module may be trained using a training data set comprising training images and wherein the training images each comprise a representation of a plurality of dockets and coordinates defining boundaries of dockets in each of the training images.

In some embodiments, the method further comprises determining, by an image validation module, an image validity score indicating validity of the image for docket detection. The method may comprise determining, by an image validation module, an image validity classification indicating validity of the image for docket detection. The image validation module comprises one or more neural networks trained to determine the image validity classification. In some embodiments, the image validation module comprises a ResNet (Residual Network) 50 or a ResNet 101 based image classification model. The method may comprise displaying an outline of the detected image segments superimposed on the image comprising the representation of the plurality of dockets.

In some embodiments, the method may comprise displaying an outline of the one or more data blocks in each of the plurality of image segments superimposed on the image comprising the representation of the plurality of dockets.

In some embodiments, the method further comprises determining a probability distribution of an association between a docket and each of a plurality of currencies to allow the classification of a docket as being related to a specific currency.

In some embodiments, the data block detection module comprises a transformer neural network. For example, the transformer neural network may comprise one or more convolutional neural network layers and one or more attention models. The one or more attention models may be configured to determine one or more relationships scores between each word in the docket text. In some embodiments, the data block detection module comprises a Bidirectional Encoder Representations from Transformers (BERT) model.

In some embodiments, the method further comprises resizing the image to a predetermined size before detecting the plurality of image segments. In some embodiments, the method comprises converting the image to greyscale the image to a predetermined size before detecting the plurality of image segments. In some embodiments, the method comprises normalising image data corresponding to the image to a predetermined size before detecting the plurality of image segments.

In some embodiments, the method comprises transmitting the data block attribute and data block value for each detected data block to an accounting system for reconciliation. The method may further comprise reconciling data block values with accounting or financial accounts.

Some embodiments relate to a system for detecting dockets and extracting docket data from images, the system comprising: one or more processors; and memory comprising computer code, which when executed by the one or more processors configure the one or more processor to: receive, an image comprising a representation of a plurality of dockets; detect, by the docket detection module of the computer system, a plurality of image segments, each image segment being associated with one of the plurality of dockets; determine, by a character recognition module of the computer system, docket text comprising a set of characters associated with each image segment; and detect, by the data block detection module of the computer system based on the docket text, one or more data blocks in each of the plurality of docket segments, wherein each data block is associated with information represented in the docket text. For example, the docket detection module and the data block detection modules may comprise one or more trained neural networks.

In some embodiments, the system may comprise determining by the data block detection module a data block attribute and a data block value for each detected data block based on the docket text, wherein the data block attribute classifies the data block as relating to one of a plurality of classes and the data block value represents the value of the determined attribute.

The data block attribute may comprise one or more of transaction date, vendor name, transaction amount, transaction tax amount, transaction currency, transaction date, payment due date, or docket number.

In some embodiments, the character recognition module may be configured to determine coordinate information associated with the docket text, and the data block detection module may determine a data block attribute and a data block value based on the docket text and the coordinate information associated with the docket text; wherein the data block attribute classifies the data block as relating to one of a plurality of classes and the data block value represents a value of the determined attribute.

In some embodiments, performing image segmentation comprises: determining, by the image segmentation module, coordinates defining a docket boundary for at least some of the plurality of dockets in the image; and extracting, by the image segmentation module, the docket segments from the image based on the determined coordinates. The one or more trained neural networks may comprise one or more deep neural networks and the data block detection is performed using a deep neural network configured to perform natural language processing.

In some embodiments, the deep neural network may be configured to perform natural language processing is trained using a training data set comprising training docket text comprising training data block values and data block attributes. The neural networks comprising the docket detection module may be trained using a training data set comprising training images and wherein the training images each comprise a representation of a plurality of dockets and coordinates defining boundaries of dockets in each of the training images and tag regions in each docket.

In some embodiments, the memory comprises computer code, which when executed by the one or more processors configures an image validation module to determine an image validity score indicating validity of the image for docket detection.

The dockets may comprise one or more of an invoice, a receipt or a credit note.

Some embodiments relate to a machine-readable medium storing computer readable code, which when executed by one or more processors is configured to perform any one of the described methods. In some embodiments, the machine-readable medium is a non-transient computer readable storage medium.

### BRIEF DESCRIPTION OF DRAWINGS

Some embodiments will now be described by way of non-limiting examples with reference to the accompanying drawings.

FIG. 1 is a block diagram of a system for processing images to detect dockets, according to some embodiments;

FIG. 2 is a process flow diagram of a method for processing images for docket detection and information extraction according to some embodiments, the method being implemented by the system of FIG. 1;

FIG. 3 is a process flow diagram of part of the method of FIG. 2, according to some embodiments;

FIG. 4 is a process flow diagram of part of the method of FIG. 2, according to some embodiments;

FIG. 5 is an example of an image, comprising a plurality of dockets, and suitable for processing by the system of FIG. 1 according to the method of FIG. 2;

FIG. 6 shows a plurality of image segments, each image segment being associated with a docket of the image of FIG. 5 and including one or more data blocks indicative of information to be extracted;

FIG. 7 shows the image segments of FIG. 6 labelled and extracted from the image of FIG. 5; and

FIG. 8 is an example of a table depicting data extracted from each of the labelled image segments of FIG. 7.

### DESCRIPTION OF EMBODIMENTS

Described embodiments relate to docket analysis methods and systems and more specifically, docket analysis methods and systems for processing images to detect dockets and extract information from the detected dockets.

Dockets may comprise documents such as invoices, receipts and/or records of financial transactions. The documents may depict data blocks comprising information associated with various parameters characteristic of financial records. For example, such data blocks may include transaction information, amount information associated with the transaction, information relating to product or service purchased as part of the transaction, parties to the transaction or any other relevant indicators of the nature or characteristics of the transaction. The dockets may be in a physical printed form and/or in electronic form.

Some embodiments relate to methods and systems to detect multiple dockets present in a single image. Embodiments may rely on a combination of Optical Character Recognition (OCR), Natural Language Processing (NLP) and Deep Learning techniques to detect dockets in a single image and extract meaningful data blocks or information from each detected docket.

Embodiments may rely on Deep Learning based image processing techniques to detect individual dockets present in a single image and segment individual dockets from the rest of the image. A part of the single image corresponding to an individual docket may be referred to as an image segment.

Embodiments may rely on OCR techniques to determine docket text present in the single image or image segments. The OCR techniques may be applied to the single image or each image segment separately. After determining text present in the single image or image segments, NLP techniques are applied to identify data blocks present in individual dockets. Data blocks may correspond to specific blocks of text or characters in the docket that relate to a piece of information. For example, data blocks may include portions of the docket that identify the vendor, or indicate a transaction date or indicate a total amount. Each data block may be associated with two aspects or properties; a data value and an attribute. The data value relates to the information or content of the data block whereas the attribute refers to the nature or type of the information data block and may include: transaction date, vendor, total amount, for example. Attributes may also be referred to as data block classes. For example, a data block with an attribute or class of “transaction date” may have a value “Sep. 29, 2019” representing the date the transaction was performed.

The Deep Learning based image processing techniques and the NLP techniques are performed using one or more trained neural networks. By availing of trained neural networks, the described embodiments can accommodate variations in the layout or structure of dockets and continue to extract appropriate information from the data blocks present in the dockets while leaving out information that may not be of interest. Further, described systems and methods do not require the knowledge of the number of dockets present in a single image before performing docket detection and data extraction.

The described docket analysis systems and methods for processing images to detect dockets and extract information provides significant advantages over known prior art systems and methods. In particular, the described embodiments allow for streamlined processing of dockets, such as dockets depicting financial records, and lessens the arduous manual processing of dockets. The described embodiments also enable processing of a plurality and in some cases, a relatively large number, of dockets in parallel making the entire process more efficient. Further, the dockets need not be aligned in a specific orientation and the described systems and methods are capable of processing images with variations in individual alignment of dockets. The automation of the process of detecting dockets and extracting information from dockets also reduces human intervention necessary to process transactions included in the dockets. With a reduced need for human intervention, the described systems and methods for processing images for docket detection may be more scalable in terms of handling a large number of dockets while providing a more efficient and low latency service requiring less human intervention.

The described docket analysis systems and methods can be particularly useful when tracking expenses, for example. As opposed to needing to take a separate image of each invoice and provide that invoice to a third party to manually extract the information of interest and populate an account record, the described technique requires only a single image representing a plurality of dockets to be acquired. From the acquired single image, the plurality of dockets may be identified and information of interest from each docket extracted. The extracted docket information may correspond to expenses incurred by employees of an organisation and based on the determined docket information, expenses may be analysed for validity and employees may be accordingly reimbursed.

The described docket analysis systems and methods may be integrated into a smartphone or tablet application to allow users to conveniently take an image of several dockets and process information present in each of the dockets. The described docket analysis systems and methods may be configured to communicate with an accounting system or an expense tracking system that may receive the docket information for further processing. Docket information may comprise data blocks determined in a docket and may, for example, specify the values and attributes corresponding to each determined data block. Accordingly, the described docket analysis systems and methods provide the practical application of efficiently processing docket information and making docket information available to other systems.

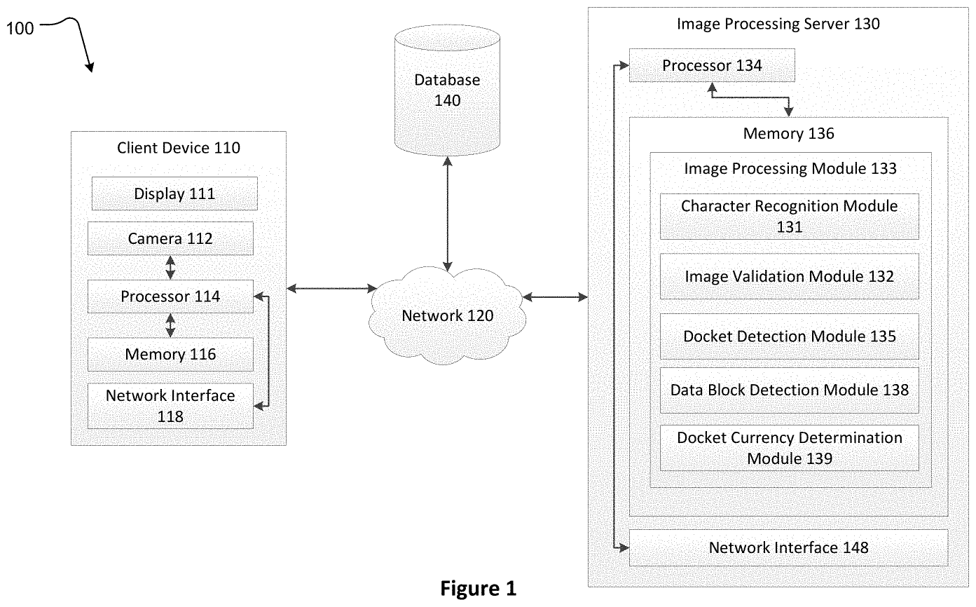

FIG. 1 is a block diagram of a system 100 for processing images to detect dockets and extract information from the dockets, according to some embodiments. For example, an image being processed may comprise a representation of a plurality of dockets. The system 100 is configured to detect a plurality of docket segments, each docket segment being associated with one of the plurality of dockets from the image.

As illustrated, the system 100 comprises an image processing server 130 arranged to communicate with one or more client device 110 and one or more databases 140 over a network 120. In some embodiments, the system 100 comprises a client-server architecture where the image processing server 130 is configured as a server and client device 110 is configured as a client computing device.

The network 120 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 108 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

In some embodiments, the client device 110 may comprise a mobile or hand-held computing device such as a smartphone or tablet, a laptop, or a PC, and may, in some embodiments, comprise multiple computing devices. The client device 110 may comprise a camera 112 to obtain images of dockets for processing by the system 100. In some embodiments, the client device 110 may be configured to communicate with an external camera to receive images of dockets.

Database 140 may be a relational database for storing information obtained or extracted by the image processing server 130. In some embodiments, the database 140 may be a non-relational database or NoSQL database. In some embodiments, the database 140 may be accessible to or form part of an accounting system (not shown) that may use the information obtained or extracted by the image processing server 130 in its accounting processes or services.

The image processing server 130 comprises one or more processors 134 and memory 136 accessible to the processor 134. Memory 136 may comprise computer executable instructions (code) or modules, which when executed by the one or more processors 134, is configured to cause the image processing server 130 to perform docket processing including docket detection and information extraction. For example, memory 136 of the image processing server 130 may comprise an image processing module 133. The image processing module 133 may comprise a character recognition module 131, an image validation module 132, a docket detection module 135, a data block detection, a data block element detection module 138 and/or a docket currency determination module 139.

The character recognition module 131 comprises program code, which when executed by one or more processors, is configured to analyse an image to determine characters or text present in the image and the location of the characters in the image. In some embodiments, the character recognition module 131 may also be configured to determine coordinate information associated with each character or text in an image. The coordinate information may indicate the relative position of a character or text in an image. The coordinate information may be used by the data block detection module 138 to more efficiently and accurately determine data blocks present in a docket. In some embodiment, the character recognition module 131 may perform one or more pre-processing steps to improve the accuracy of the overall character recognition process. The pre-processing steps may include de-skewing the image to align the text present in the image to a more horizontal or vertical orientation. The pre-processing steps may include converting the image from colour or greyscale to black and white. In dockets with multilingual text, pre-processing by the character recognition module 131 may include recognition of the script in the image. Another pre-processing step may include character isolation involving separation of parts of the image corresponding to individual characters.

The character recognition module 131 performs recognition of the characters present in the image. The recognition may involve the process of pattern matching between an isolated character from the image against a dictionary of known characters to determine the most similar character. In alternative embodiments, character recognition may be performed by extracting individual features from the isolated character and comparing the extracted individual features with known features of characters to identify the most similar character. In some embodiments, the character recognition module 131 may comprise a linear support vector classifier based model for character recognition.

In some embodiments, the image validation module 132 may comprise program code to analyse an image to determine whether the image meets quality and/or comprises relevant content for it to be validly processed by the character recognition module 131, the docket detection module 135, and/or the data block detection module 138. The image validation module 132 may process an image received by the image processing server 130 to determine a probability score of the likelihood of an image being validly processed and accurate information being extracted from the image by one or more of the other modules of the image processing server 130.

In some embodiments, the image validation module 132 may comprise one or more neural networks configured to classify an image as valid or invalid for processing by the image processing server 130. In some embodiments, the image validation module 132 may incorporate a ResNet (Residual Network) 50 or a ResNet 101 based image classification model. In some embodiments, the image validation module 132 may also perform one or more pre-processing steps on the images received by the image classification server 130. The pre-processing steps may include: resizing the images to a standard size before processing, converting an image from colour to greyscale, normalizing the image data, for example.

The image validation module 132 may be trained using a training dataset that comprises valid images that meet the quality or level of image detail required to be for docket detection and data block detection. The training dataset also comprises images that do not meet the quality or level of image detail required to be for docket detection and data block detection. During the training process the one or more neural networks of the image validation module 132 are trained or calibrated or the respective weights of the neural networks as adjusted generalise or parameterise or model the image attribute associated with the valid and invalid images in the training dataset. The image validation module 132 once trained performs classification or determination of the probability of an image being validly processed based on the respective weights of the various neural networks in the image validation module 132.

In some embodiments, the docket detection module 135 and the data block detection module 138 may be implemented using one or more deep neural networks. In some embodiments, one or more of the Deep Learning neural networks may be a convolutional neural network (CNN). Existing reusable neural network frameworks such as TensorFlow, PyTorch, MXNet, Caffe2 may be used to implement the docket detection module 135 and the data block detection module 138. In some embodiments, the data block detection module 138 may receive, as an input, docket text including a sequence of words, labels and/or characters recognised by the character recognition module 131 in a docket detected by the docket detection module 135. In some embodiments, the data block detection module 138 may also receive, as input, coordinates of each of the label words, labels and/or characters in the docket text recognised by the character recognition module 131. Use of coordinates of each of the label words, labels and/or characters in the docket text may provide improved accuracy and performance in the detection of data blocks by data block detection module 138. The coordinate information relating to label words, labels and/or characters in the docket text may provide spatial information to the data block detection module 138 allowing the models within the data block detection module 138 to leverage the spatial information in determining data blocks within a docket.

In some embodiments, the data block detection module 138 may produce, as an output, one or more data blocks in each docket detected by the docket detection module 135. Each data block may relate to a specific category of information associated with a docket, for example a currency associated with the docket, a transaction amount, one or more dates such as an invoice date or due date, vendor detail, an invoice or docket number, and a tax amount.

A CNN, as implemented in some embodiments, may comprise multiple layers of neurons that may differ from each other in structure and their operation. The first layer of a CNN may be a convolution layer of neurons. The convolution layer of neurons performs the function of extracting features from an input image while preserving the spatial relationship between the pixels of the input image. The output of a convolution operation may include a feature map of the input image, the feature map identifying multiple dockets detected in the input image and one or more data blocks determined in each docket. An example of the feature map is shown in FIG. 6, as discussed in more detail below.

After a convolution layer, the CNN, in some embodiments, implements a pooling layer or a rectified linear units (ReLU) layer or both. The pooling layer reduces the dimensionality of each feature map while retaining the most important feature information. The ReLU operation introduces non-linearity in the CNN since most of the real-world data to be learned from the input images would be non-linear. A CNN may comprise multiple convolutional, ReLU and pooling layers wherein the output of an antecedent pooling layer may be provided as an input to a subsequent convolutional layer. This multitude of layers of neurons is a reason why CNNs are described as a Deep Learning algorithm or technique. The final layer one or more layers of a CNN may be a traditional multi-layer perceptron neural network that uses the high-level features extracted by the convolutional and pooling layers to produce outputs. The design of CNN is inspired by the patterns and connectivity of neurons in the visual cortex of animals. This basis for the design of CNN is one reason why a CNN may be chosen for performing the functions of docket detection and data block detection in images.

In some embodiments, the data block detection module 138 may be implemented using a transformer neural network. The transformer neural network of the data block detection module 138 comprises one or more CNN layers and one or more attention models, in particular self-attention models. A self-attention model models relationships between all the words or labels in a docket text received by the docket detection module 135 regardless of their respective position. As part of a series of transformations performed by a transformer neural network, the data block detection module 138, an attention score for every other word in a docket text may be determined by the data block detection module 138. The attention scores are then used as weights for a weighted average of all words' representations which is fed into a feedforward neural network or a CNN to generate a new representation for each word in a docket text, reflecting the significance of the relationship between each combination or a pair of words. In some embodiments, the docket detection module 135 may incorporate a Bidirectional Encoder Representations from Transformers (BERT) based model for processing docket text to identify one or more data blocks associated with a docket.

The docket detection module 135, when executed by the processor 134, enables the detection of dockets in an input image comprising a representation of a plurality of dockets received by the image processing server 130. The docket detection module 135 is a model that has been trained to detect dockets based on a training dataset comprising images and an outline of dockets present in the images. The training dataset may comprise a large variety of images with dockets in varying orientations. The boundaries of the dockets in the training dataset images may be identified by manual inspection or annotation. Coordinates associated with the boundaries of dockets may serve as features or target parameters to enable training of the models of the docket detection module 135. The training dataset may also comprise annotations or labels associated with attributes, values with associated attributes and boundaries around the image regions corresponding to one or more data blocks within a docket. The labels associated with attributes, values and coordinates defining boundaries around data blocks may serve as features or target parameters to enable training of the models of the docket detection module 135 to identify data blocks. During the training process, the target parameters may be used to determine a loss or error during each iteration of the training process in order to provide feedback to the docket detection module 135. Based on the determined error or loss, the weights of the neural networks within the docket detection module 135 may be updated to model or generalise the information provided by the target parameters in the training dataset. A diverse training dataset comprising several different input image types with different configurations of dockets is used to provide a more robust output. An output of the docket detection module 135 may, for example, identify the presence of dockets in an input image, the location of the dockets in the input image and/or an approximate boundary of each detected docket. Accordingly, the knowledge or information included in the diverse training dataset may be generalised, extracted and encoded by the parameters defining the docket detection module 135 through the training process.

The data block detection module 138, when executed by the processor 134, enables the determination of one or more data blocks in the dockets detected by the docket detection module 135. The data block detection module 138 comprises models that have been trained to detect data blocks in dockets. The data block detection module 138 also comprises models that have been trained to identify an attribute and value associated with each detected data block.

The models of the data block detection module 138 are trained based on a training dataset. The training dataset comprises text extracted from dockets, data blocks defined by the text, and attributes and values of each data block. A diverse training dataset may be used comprising several different docket types with different kinds of data blocks, which may provide a more robust output. An output of the data block detection module 138 may include an indicator of the presence of one or more data blocks in a detected docket, the location of the detected data block and/or an approximate boundary of each detected data block.

The models of the data block detection module 138 may be in the form of a neural network for natural language processing. In particular, the models may be in the form of a Deep Learning based neural network for natural language processing. Deep Learning based neural network for natural language processing comprises an artificial neural network formed by multiple layers of neurons. Each neuron is defined by a set of parameters that perform an operation on an input to produce an output. The parameters of each neuron are iteratively modified during a learning or training stage to obtain an ideal configuration to perform the task desired of the entire artificial neural network. During the learning or training state, the models included in the data block detection module 138 are iteratively configured to analyse a training text to determine data blocks present in the input text and identify the attribute and value associated with each data block. The iterative configuration or training comprises varying the parameters defining each neuron to obtain an optimal configuration in order to produce more accurate results when the model is applied to real-world data.

The docket currency determination module 139 may comprise program code, which when executed by one or more processors, is configured to process an image relating to a docket and determine a currency value the docket may be associated with. For example, the docket currency determination module 139 may process docket text extracted by the character recognition module 131 relating to a docket and determine a currency value associated with the docket. In some embodiments, the docket currency determination module 139 may determine a probability distribution of an association between a docket and each of a plurality of currencies to allow the classification of a docket as being related to a specific currency. For example, an image comprising multiple dockets may relate to invoices or receipts or documents with transactions performed in distinct currencies. Accurate estimation of the currency a docket may be associated with may allow for improved and more efficient processing of transaction information in a docket.

The docket currency determination module 139 may comprise one or more neural networks to classify or associate a docket with a specific currency. In some embodiments, the docket currency determination module 139 may comprise one or more Long short-term memory (LSTM) artificial recurrent neural networks to perform the currency classification task. Examples of specific currency classes that a docket may be classified into include: US dollar, Canadian dollar, Australian dollar, British pound, New Zealand dollar, Euro and any other currency that the models within the docket currency determination module 139 may be trained to identify. In some embodiments, the data block detection module 138 may invoke or execute the docket currency determination module 139 to determine a currency to associate with a docket text.

In some embodiments, the output from the docket detection module 135 and/or data block detection module 138 may be presented to a user on a user interface of the client device 110. An example of an input image which has been processed to detect image or docket segments and determine data blocks within those docket segments is illustrated in FIG. 6.

The image processing server 130 also comprises a network interface 148 for communicating with the client device 110 and/or the database 140 over the network 120. The network interface 148 may comprise hardware components or software components or a combination of hardware and software components to facilitate the communication to and from the network 120.

FIG. 2 is a process flow diagram of a method 200 of processing images for docket detection and information extraction, according to some embodiments. The method 200 may be implemented by the system 100. In particular, one or more processors 134 of the image processing server 130 may be configured to execute the image processing module 133 and character recognition module 131 to cause the image processing server 130 to perform the method 200. In some embodiments, image processing server 130 may be configured to execute the image validation module 132 and/or the docket currency determination module 139 to cause the image processing server 130 to perform the method 200.

Referring now to FIG. 2, an input image is received from client device 110 by the image processing server 130, at 210. The input image comprises a representation of a plurality of dockets, each docket including one or more data blocks comprising a specific type of information associated with the docket. For example, where the docket relates to a financial record, such as an invoice, docket data blocks may include information associated with one of the issuers of the invoice, account information associated with the issuer, an amount due and a due date for payment. The input image may be obtained using camera 112 of the client device 110 or otherwise acquired by client device 110, and transmitted to the image processing server 130 over the network 120. In other embodiments, the image processor server functionality may be implemented by the processor 114 of the client device 110.

In some embodiments, the method 200 may optionally comprise determining the validity of the received input image, at 215. In particular, the image validation module 132 may process the received image to determine a validity score or a probability score associated with the validity or quality of the received image. If the calculated validity score falls below a predetermined validity score threshold, then the received image may not be further processed by the image processing device 130 to avoid producing erroneous outcomes at subsequent steps in the method 200. In some embodiments, the image processing device 130 may transmit a communication to the client device indicating the invalidity of the image transmitted by the client device 110 (such as an error message or sound) and may request a replacement image. If the determined validity score exceeds the predetermined validity threshold, the image is effectively validated and method 200 continues.

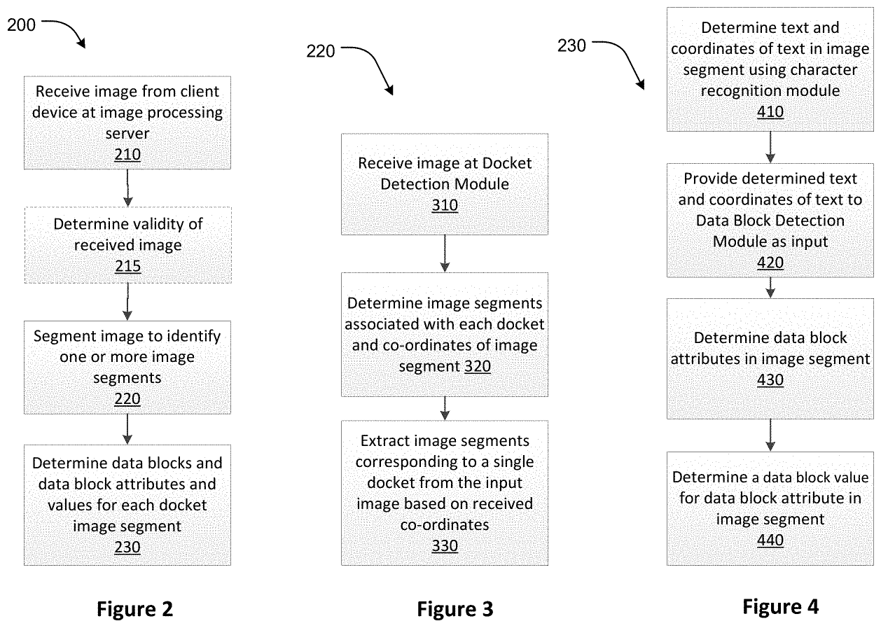

After receiving the input image by the image processing server 130, (and optionally validating the image), the docket detection module 135 processes the image to determine a plurality of image segments, each image segment being associated with one of the plurality of dockets, at 220. For example, the docket detection module 135 may segment the image and identify the plurality of image segments in the input image, at 220. This is discussed in more detail below with reference to FIG. 3.

In some embodiments, the character recognition module 131 performs optical character recognition on the input image before the input image is processed by the docket detection module 135, or in parallel with the input image being processed by the docket detection module 135. In other embodiments, the character recognition module 131 performs optical character recognition on the image segments determined by the docket detection module 135. In other words, the OCR techniques may be applied to the single image before, concurrently or after the docket detection module 135 processes the input image, or may be applied to each image segment separately once the image segments are received from the docket detection module 135. The character recognition module 131 therefore determines characters and/or text in the single image as a whole or in each of the image segments.

The data block detection module 138 identifies one or more data blocks in each of the plurality of image segments, at 230. For example, the data block detection module 138 may identify data blocks based on characters and/or text recognised in the image segments by the character recognition module 131. In some embodiments, the data block detection module 138 may determine an attribute (or data block attribute) associated with each data block in a docket. The attribute may identify the data block as being associated with a particular class of a set of classes. For example, the attribute may be a transaction date attribute, or a vendor name attribute or a transaction amount attribute. In some embodiments, the data block detection module 138 may determine a value or data block value associated with each data block in a docket. The value may be, for example, a transaction date of “Sep. 26, 2019” or a transaction amount of “$100.00”.

In some embodiments, the image processing server 130 may provide one or more of the image segments, the data blocks and associated attributes and attribute values, to a database for storage, and/or to a further application, such as a reconciliation application for further processing.

FIG. 3 depicts a process flow of a method 220 of processing the input image to determine a plurality of image segments as performed by the docket detection module 135, according to some embodiments. The input image received by the image processing server 130 (and optionally validated by the validation module 132) is provided as an input to the docket detection module 135, at 310. In some embodiments, pre-processing operations may be performed at this stage to improve the efficiency and accuracy of the output of the docket detection module 135 as discussed above. For example, the input image may be converted to a black and white image, appropriate scaling of the input image, skew correction or correcting any tilted orientation, noise removal. In some embodiments, the validity of the received input image may be verified.

The docket detection module 135 detects dockets present in the input image. The docket detection module 135 may determine one or more coordinates associated with each docket, at 320. The determined one or more coordinates may define a boundary, such as a rectangular boundary, around each detected docket to demarcate a single docket from other dockets in the image and/or other regions of the image not detected as being a docket. Based on coordinates determined at 320, an image segment corresponding to each docket is extracted, at 330.

The coordinates determined at step 320 enable the definition of a boundary around each docket identified in the input image. The boundary enables the extraction of image segments from the input image that correspond to a single docket. As a result of method 220, an input image comprising a representation of multiple dockets is segmented into a plurality of image segments, with each image segment corresponding to a single docket.

The image segments extracted through method 220 may be individually processed by the character recognition module 131 to determine docket text including a sequence of words, labels and/or characters. The determined docket text may be made available to the data block detection module 138 to determine one or more data blocks present in an image segment.

FIG. 4 depicts a process flow of a method 230 of processing the image segments to determine data blocks, as performed by the data block detection module 138, according to some embodiments. In some embodiments, image segments extracted at step 330 are provided as input to the character recognition module 131 to determine docket text or characters present in the image segments, at 410. In some embodiments, the character recognition module 131 may also be configured to determine coordinates of docket text or a part of a docket text indicating the relative position of the docket text or part of the docket text within an image segment. Step 410, may also be performed at an earlier stage in the process flow 200 of FIG. 2, including before the image segmentation step 220 or may be performed in parallel (concurrently). For example, the received image may be provided to the character recognition module 131 to determine docket text or characters present in the image (unsegmented). Determination of text and/or characters at step 410 may also include determination of location or coordinates corresponding to the location of the determined text and/or characters in the image segments. Since several image segments may be identified in a single input image, the steps 410 to 440 may be performed for each identified image segment.

The docket text and/or characters and/or coordinates of the docket text or parts of docket text determined at step 410 are provided to the data block detection module 138, at 420. In some embodiments, the text and/or characters may be provided to the data block detection module 138 as sequential text or in the form of a single sentence.

The data block detection module 138 detects one or more docket data blocks and/or data block attributes present in the image segment based on the text or characters determined by the character recognition module 131, at 430. The data block detection module determines values or data block values in each determined data block, at 430. The values may include a total amount of “$100.00” or transaction date of “Sep. 27, 2019”, for example. The data block detection module determines attributes or data block attributes for each determined data block, at 440. The attributes may include a “Total Amount” or “Transaction Date” or “Vendor Name”, for example. The coordinates determined at step 410 may enable the definition of a rectangular boundary around each detected data block in the image segment.

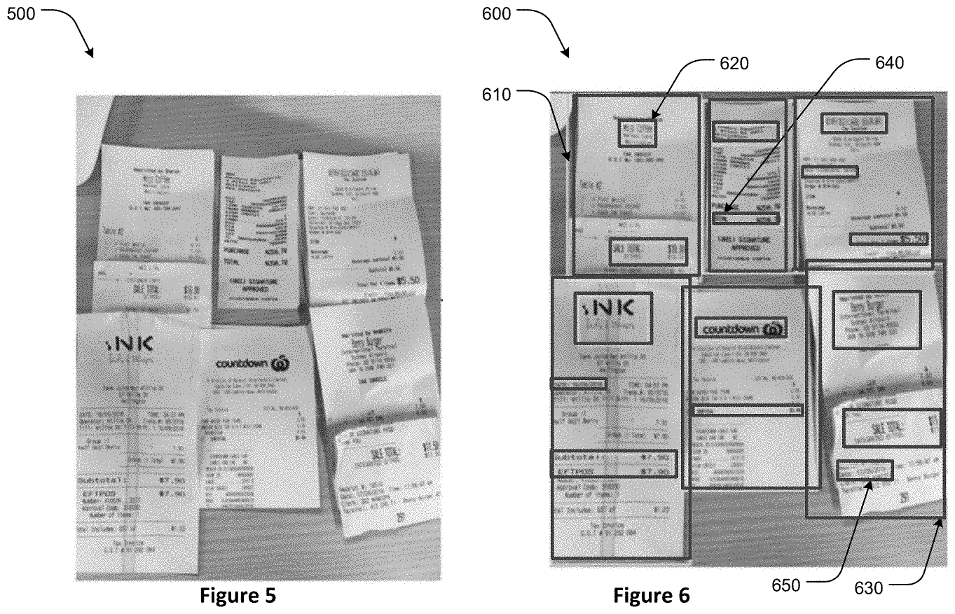

FIG. 5 is an example of an image 500, comprising a representation of a plurality of dockets, suitable for processing by the system 100 according to the method 200.

FIG. 6 illustrates a plurality of image segments, each image segment being associated with a docket of the image of FIG. 5 and including one or more detected docket data blocks indicative of information to be extracted. The image segments associated with the dockets have been determined using the method 220, 300 and the data blocks have been determined using the method 230, 400. Boundaries 610, 630 surround dockets automatically detected by the docket detection module 135. Boundaries 620, 640 and 650 surround data blocks automatically determined by the data block detection module 138. As exemplified by the detected docket boundary 630, the docket need not be aligned in a particular orientation to facilitate docket or data block detection. The docket detection module 135 is trained to handle variations in orientations or partial collapsing of dockets in the input image as exemplified by the boundary 650. Docket data block boundaries surround the various transaction parameters detected by the docket data block detection module 138. For example, the docket tag boundary 620 surrounds a vendor name, data block boundary 640 surrounds a total amount and docket data block boundary 650 surrounds a transaction date. The extracted image segments and/or the docket data block boundaries may be presented to a user through a display 111 on the client device 110. The extracted image segments and/or the docket data block boundaries may be identified using an outline or a boundary. The extracted image segments and/or the docket data block boundaries may be overlayed or superimposed on an image of the docket to provide the user a visual indication of the result of the docket detection and information extraction processes.

FIG. 7 shows the image segments of FIG. 6 labelled and extracted from the image of FIG. 5. Each detected data block is labelled by the image processing module 133 to identify and refer to each detected docket separately. As an example, the docket bounded by boundary 720 is assigned the label 710, which in this case is 4.

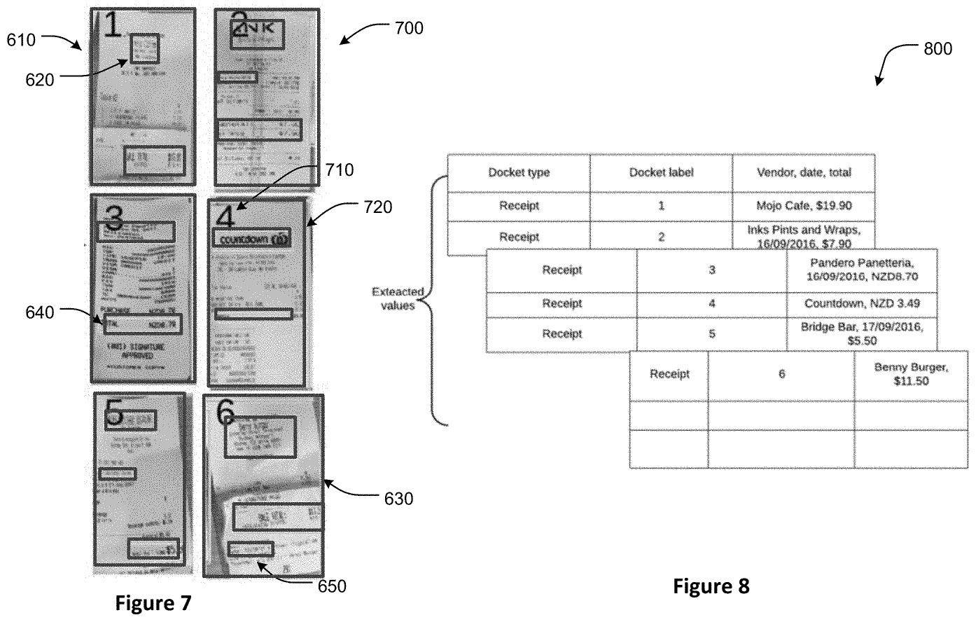

FIG. 8 is an example of output a table depicting data 800 extracted from each of the labelled image segments shown in FIG. 7 by the system 100 of FIG. 1. The table illustrates docket data block attributes and data block values for each determined docket data block in each identified docket. In the table, for example, the docket labelled 2 has been determined as being associated with the vendor “Inks Pints and Wraps”, the date Sep. 16, 209 and an amount of $7.90.

The information extracted using the docket detection and information extraction methods and systems according to the embodiments may be used for the purpose of data or transaction reconciliation. In some embodiments, the information extracted using the docket detection and information extraction methods and systems may be transmitted to or may be made accessible to an accounting system or a system for storing, manipulating and/or reconciling accounting data. The extracted information, such as transaction date, vendor name, transaction amount, transaction currency, transaction tax amount, transaction due date, or docket number may be used within the accounting system to reconcile the transaction associated in a docket with one or more transaction records in the accounting system. The embodiments accordingly allow efficient and accurate extraction, tracking and reconciliation of transactional data by automatically extracting transaction information from dockets and making it available to an accounting system for reconciliation. The embodiments may also allow the extraction transaction information from dockets associated with expenses by individuals in an organisation. The extracted information may be transmitted or made available to an expense claim tracking system to track, approve and process expenses by individuals in an organisation.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer implemented method for processing images for docket detection and information extraction, the method comprising:
receiving, at a computer system, an image comprising a representation of a plurality of dockets;
detecting, by a docket detection module of the computer system, a plurality of image segments, each image segment being associated with one of the plurality of dockets;
determining, by a character recognition module of the computer system, docket text comprising a set of characters associated with each image segment; and
detecting, by a data block detection module of the computer system, based on the docket text, one or more data blocks in each of the plurality of image segments, wherein each data block is associated with a type of information represented in the docket text.

2. The computer implemented method of claim 1, wherein the docket detection module and the data block detection modules comprise one or more trained neural networks.

3. The method of claim 1, further comprising:
determining, by the data block detection module, a data block attribute and a data block value for each detected data block based on the docket text,
wherein the data block attribute classifies the data block as relating to one of a plurality of classes and the data block value represents a value of the determined attribute.

4. The method of claim 1, further comprising:
determining, by the character recognition module, coordinate information associated with the docket text; and
determining, by the data block detection module, a data block attribute and a data block value based the docket text and the coordinate information associated with the docket text;
wherein the data block attribute classifies the data block as relating to one of a plurality of classes and the data block value represents a value of the determined attribute.

5. The method of claim 3, wherein the data block attribute comprises one or more of: transaction date, vendor name, transaction amount, transaction currency, transaction tax amount, transaction due date, and/or docket number.

6. The method of claim 1, wherein detecting, by the docket detection module, the plurality of image segments comprises:
determining, by an image segmentation module, coordinates defining a docket boundary for at least some of the plurality of dockets in the image; and
extracting, by the image segmentation module, the image segments from the image based on the determined coordinates.

7. The method of claim 2, wherein the one or more trained neural networks comprise one or more deep neural networks and wherein detecting by the data block detection module, the one or more data blocks comprises performing natural language processing using a deep neural network.

8. The method of claim 7, wherein the deep neural network configured to perform natural language processing is trained using a training data set comprising training docket text comprising training data block values and data block attributes.

9. The method of claim 1, wherein the neural networks comprising the docket detection module are trained using a training data set comprising training images and wherein the training images each comprise a representation of plurality of dockets and coordinates defining boundaries of dockets in each of the training images.

10. The method of claim 1, wherein the dockets comprise one or more of an invoice, a receipt or a credit note.

11. The method of claim 1, further comprising determining, by an image validation module, an image validity classification indicating validity of the image for docket detection.

12. The method of claim 11, wherein the image validation module comprises one or more neural networks trained to determine the image validity classification.

13. (canceled)

14. (canceled)

15. (canceled)

16. The method of claim 1, further comprising determining a probability distribution of an association between a docket and each of a plurality of currencies to allow classification of a docket as being related to a specific currency.

17. The method of claim 1, wherein the data block detection module comprises a transformer neural network.

18. The method of claim 1, wherein the transformer neural network comprises one or more convolutional neural network layers and one or more attention models.

19. The method of claim 15, wherein the one or more attention models are configured to determine one or more relationships scores between each words in the docket text.

20. The method of claim 1, wherein the data block detection module comprises a Bidirectional Encoder Representations from Transformers (BERT) model.

21. The method of claim 1, further comprising one or more of:
(i) resizing the image to a predetermined size before detecting the plurality of image segments;
(ii) converting the image to greyscale before processing detecting the plurality of image segments;
(iii) normalising image data corresponding to the image before detecting the plurality of image segments.

22. (canceled)

23. (canceled)

24. (canceled)

25. A system for detecting dockets and extracting docket data from images, the system comprising:
one or more processors; and
memory comprising computer code, which when executed by the one or more processors is configured to cause the one or more processor to:
receive, an image comprising a representation of a plurality of dockets;
detect, by a docket detection module of the computer system, a plurality of image segments, each image segment being associated with one of the plurality of dockets;
determine, by a character recognition module of the computer system, docket text comprising a set of characters associated with each image segment; and
detect, by a data block detection module of the computer system based on the docket text, one or more data blocks in each of the plurality of image segments, wherein each data block is associated with information represented in the docket text.

26.-36. (canceled)

37. A non-transient machine-readable medium storing computer readable code, which when executed by one or more processors is configured to:
receive, an image comprising a representation of a plurality of dockets;
detect, by a docket detection module of the computer system, a plurality of image segments, each image segment being associated with one of the plurality of dockets;
determine, by a character recognition module of the computer system, docket text comprising a set of characters associated with each image segment; and
detect, by a data block detection module of the computer system based on the docket text, one or more data blocks in each of the plurality of image segments, wherein each data block is associated with information represented in the docket text.
